(19) United States
(12) Patent Application Publication
(10) Pub. No.: US 2014/0227954 A1
(43) Pub. Date: Aug. 14, 2014

(54) BLOWER AND VENTILATION SYSTEM

(71) Applicants: TOKYO METROPOLITAN SEWERAGE SERVICE CORPORATION, Tokyo (JP); EBISMARINE CORPORATION, Nagasaki-shi (JP); EBISTRADE, INC., Tokyo (JP)

(72) Inventors: Keiichi SONE, Chiyoda-ku (JP); Hiroyuki TAMAMOTO, Chiyoda-ku (JP); Katsutoshi YOSHINAGA, Nagasaki-shi (JP); Hironao KASAI, Nagasaki-shi (JP); Kenichiro YOKOO, Nagasaki-shi (JP); Ryoji TERAI, Chiyoda-ku (JP); Takeshi ABE, Ota-ku (JP)

(73) Assignees: TOKYO METROPOLITAN SEWERAGE SERVICE CORPORATION, Tokyo (JP); EBISTRADE, INC., Tokyo (JP); EBISMARINE CORPORATION, Nagasaki-shi (JP)

(21) Appl. No.: 14/252,177

(22) Filed: Apr. 14, 2014

Related U.S. Application Data
(63) Continuation of application No. PCT/JP2012/076385, filed on Oct. 12, 2012.

(30) Foreign Application Priority Data
Oct. 13, 2011 (JP) 2011-225390

(51) Int. Cl. E03F 5/08; B05B 9/03; B05B 9/04; B05B 15/06; B05B 1/14

(52) U.S. Cl. CPC E03F 5/08; B05B 15/066; B05B 1/14; B05B 9/04; B05B 9/035; B05B 15/061
USPC 454/48; 239/273; 239/589; 239/556; 454/252

(57) ABSTRACT

There is provided is a blower installed at a manhole opening, with which it is possible to facilitate an entry or an exit of a worker or an import or an export of an article. The present invention provides a ventilation system in a pipe conduit using the blower. Provided is a blower comprising: a ring-like or circular arc-like frame; a nozzle installed continuously or discontinuously along the frame; and compressed air supplying means for supplying the nozzle with compressed air, wherein the compressed air supplied from the compressed air supplying means is emitted while swallowing up air in the nozzle or near the nozzle, whereby, an airflow to a normal direction of a disk surface of which the flame is periphery is generated. The nozzle may be a nozzle for exhausting an air flown from an entry port of a cylindrical flow channel to an exit port of the cylindrical flow channel, and a plurality of the nozzles may be discontinuously installed along the frame.

### TECHNICAL FIELD

The present invention relates to a blower and a ventilation system. In particular, the present invention relates to a blower and a ventilation system preferably applied to an underground pipe conduit or an underground pipe line.

### BACKGROUND ART

In an underground pipe conduit or an underground pipe line (hereinafter, simply referred to as “pipe conduit”) such as a sewer, when a manual work such as a maintenance and inspection is carried out, a worker generally enters from a manhole into a pipe conduit. In the pipe conduit, a worker may be in an oxygen deficiency state, and a poisonous gas such as hydrogen sulfide may be generated, and thus, it is needed to ensure safety management for a worker staying in the pipe conduit.

Non Patent Literature 1 is a report on a safety in work in a sewer pipe conduit and provides recommendations and specific safety issues based on analysis of an accident case. In particular, on page 27 of the Non Patent Literature 1, a method of ventilating in a pipe conduit is described, in which “a fan is installed in consideration of a wind direction of an outer air, and the air is blown from one side and the air is exhausted to outside from the other side thereby to carry out a ventilation in the pipe conduit. The wind speed in the pipe conduit at this time should be over 0.8 m/second.” The Literature illustrates an image of a cleaning work, and provides also an example of a fan and a duct by way of photo. According to the image of the cleaning work, ducts are inserted into both manholes at an air-blow side and an air-exhaust side, and the air is blown and exhausted by the fan connected to a ground surface side of each duct.

It is noted that Patent Literature 1 discloses an intake and exhaust device for a manhole, and Patent Literature 2 discloses a ventilator for an underground structure.

### CITATION LIST

### Patent Literature

[PTL 1] Japanese Unexamined Patent Application Publication No. 2000-104966
[PTL 2] Japanese Unexamined Patent Application Publication No. 2003-328378

### Non Patent Literature

[NPL 1] “Intermediate report on safety management on work within sewer pipe conduit”, Sewer Pipe Conduit Work Safety Management Committee, April, 2002 (http://jascoma.com/siryou/k_{—}200804_cyukanhoukoku.pdf)

### SUMMARY OF INVENTION

### Technical Problem

When the fan and the ducts are applied to the manhole as stated in the “image of a cleaning work” described in Non Patent Literature 1 so that the air is blown and exhausted, it is possible to ensure the safety of a worker and it is needed to do so in order to ensure safety in work. On the other hand, a duct inserted into the manhole blocks the manhole opening, and when the duct is inserted into the manhole, it is inconvenient to make an entry or an exit of a worker and an import or an export of a component. Further, when there is no space for an entry or an exit of a person or for an import or an export of an article between the manhole opening and the duct, it is needed to remove the duct from the manhole, resulting in a situation where the air needs be temporarily stopped from being blown or exhausted, hence it is not preferable for the safety management. In addition, when an emergency such as a generation of poisonous gas occurs during a work in the pipe conduit, it is needed to immediately evacuate the worker from the pipe conduit.

An object of the present invention is to provide a blower which is installed at a manhole opening and is possible to facilitate an entry or an exit of a worker or an import or an export of an article. Further, an object of the present invention is to provide a ventilation system in a pipe conduit using the blower.

### Solution to Problem

To solve the above-described problem, according to a first aspect of the present invention, there is provided a blower comprising: a ring-like or circular arc-like frame; a nozzle arranged continuously or discontinuously along the frame; and compressed air supplying means for supplying the nozzle with compressed air, wherein the compressed air supplied from the compressed air supplying means is emitted while swallowing up air in the nozzle or near the nozzle, whereby, an airflow to a normal direction of a disk surface of which the frame is periphery is generated.

The nozzle may be a nozzle for exhausting an air flown from an entry port of a cylindrical flow channel to an exit port of the cylindrical flow channel, and a plurality of the nozzles may be discontinuously installed along the frame. There may be provided an outlet, from which compressed air is emitted toward the exit port, on a wall surface of the cylindrical flow channel, and the compressed air emitted from the outlet may be flown in a direction of the exit port while swallowing up the air in the cylindrical flow channel to thereby generate an airflow in the cylindrical flow channel.

Each of the plurality of nozzles may be arranged toward one point on a normal line of the center of a disk surface of the frame. The number of nozzles may be four, and the four nozzles may be arranged at equal intervals along the frame.

It may be possible to include an installation tool for installing the nozzle to the frame, and it is preferable that the installation tool includes an angle adjustment mechanism for adjusting an angle of the nozzle relative to the disk surface of the frame. The installation tool may include a clamp part for clamping the frame, and in this case, by the clamp part, the nozzle is detachable from the frame, and the angle of the nozzle is adjustable.

The frame may be configured by a plurality of members, and in this case, it is possible that when transported, the frame includes either one of: a first configuration where the frame is separated in the members; or a second configuration where the frame is folded in a manner that the plurality of members are laid on top of one another. A fixing tool for fixing the frame at the manhole opening may be further provided. Further, it may be possible to further include a blocking member for blocking a gap between a circumferential area of the manhole opening and the frame. Furthermore, it may be possible to further include an airflow reflection member which is installed at the manhole opening, is a flexible member dropped to a lower part in a manhole and converts a direction of an airflow from a vertical direction to a horizontal direction. Also, it may be possible to further include aromatic supplying means for supplying air or the compressed air flown to the nozzle with an aromatic.

According to a second aspect of the present invention, there is provided a ventilation system of an underground pipe conduit or an underground pipe line, using the blower, wherein the blower is installed in at least one manhole out of a plurality of manholes connected to the underground pipe conduit or the underground pipe line, and an exhaust device is installed in at least one of other manholes different from the manhole in which the blower is installed.

The exhaust device may be installed in a first manhole on a downstream side of the manhole in which the blower is installed. An airflow reflection plate for converting a direction of airflow from a vertical direction to a horizontal direction or from a horizontal direction to a vertical direction may be installed on a bottom of either one or both of the manhole in which the blower is installed and the manhole in which the exhaust device is installed.

It is noted that the above-described Summary of Invention does not list all the characteristics necessary for the present invention. Further, a sub-combination of these groups of characteristics may be invention.

### BRIEF DESCRIPTION OF DRAWINGS

FIG. 1 is a cross-sectional view showing an example of a ventilation system of a sewer pipe conduit.

FIG. 2 is a cross-sectional view showing an example of a blower 140 arranged at a manhole opening.

FIG. 3 is a perspective view showing an example of a blower 140 arranged at a manhole opening.

FIG. 4 is a cross-sectional view enlarging and showing an example of a nozzle 144.

FIG. 5 is a graph showing a wind speed of a blower in Example 1 as a function of a distance.

FIG. 6 is a reference photograph showing a state where a blower is arranged at a manhole opening at an air-blow side.

FIG. 7 is a reference photograph showing a state where a duct of a fan-type exhaust device is inserted into a manhole opening at an air-exhaust side.

FIG. 8 is a reference photograph showing a state where air is blown into a manhole in a state that a blower is operated.

FIG. 9 is a cross-sectional view showing another example of a ventilation system of a sewer pipe conduit.

FIG. 10 is a cross-sectional view showing still another example of a ventilation system of a sewer pipe conduit.

FIG. 11 is a cross-sectional view showing yet another example of a ventilation system of a sewer pipe conduit.

FIG. 12 is a cross-sectional view showing another example of a blower 140 arranged at a manhole opening.

FIG. 13 is a cross-sectional view showing further example of a ventilation system of a sewer pipe conduit.

### DESCRIPTION OF EMBODIMENTS

Hereinafter, the present invention will be described by way of an embodiment of the present invention, however, an following embodiment does not limit the invention as set forth in the scope of claims. Further, all the combinations of characteristics described in the embodiment are not necessary essential for the means for solving the invention.

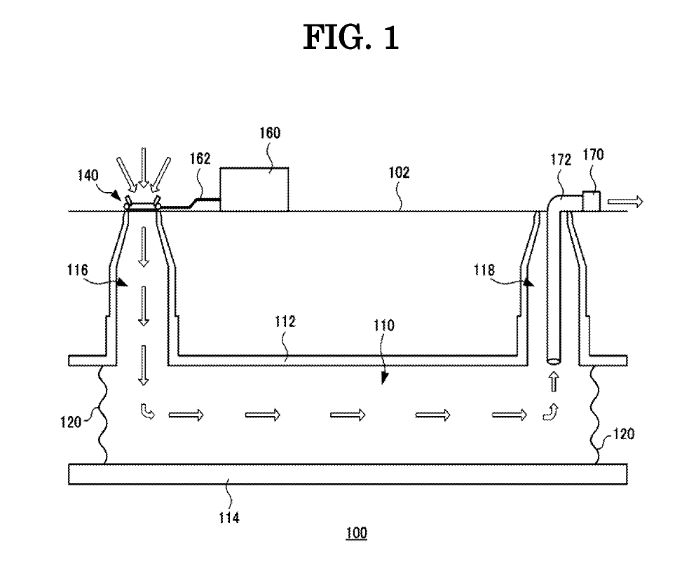

FIG. 1 is a cross-sectional view showing an example of a ventilation system of a sewer pipe conduit. A ventilation system 100 ventilates a pipe conduit 110 buried beneath a ground surface 102. The pipe conduit 110 is an underground space divided by a bottom 114 and a wall surface 112, and includes a cross-sectional surface having a shape of a horseshoe. Between the pipe conduit 110 and the ground surface 102, a manhole 116 and a manhole 118 are arranged, and a worker is capable of entering the pipe conduit 110 through the manhole 116 or the manhole 118. In the present embodiment, description proceeds with a case where the pipe conduit 110 between the manhole 116 and the manhole 118 is ventilated. The manhole 116 is at an air-blow side and the manhole 118 is at an air-exhaust side. In this case, description proceeds with a case where the manhole 116 and the manhole 118 are adjacent to each other, however, the manhole 116 and the manhole 118 need not be adjacent to each other. In order to shield a pipe conduit region between the manhole 116 and the manhole 118 from another pipe conduit region, a shield curtain 120 may be arranged in the pipe conduit 110. The shield curtain is efficient in ventilation.

A blower 140 is installed at an opening of the manhole 116 at the air-blow side, and an exhaust device 170 is installed at the manhole 118 at the air-exhaust side. The exhaust device 170 is a conventional fan-type exhaust device, and a duct 172 connected to the exhaust device 170 is inserted into the manhole 118. It is noted that the blower 140 may be installed at a plurality of manholes, and the exhaust device 170 may be installed at a plurality of manholes. Further, the manhole 118 is preferably the first manhole on downstream side of the manhole 116. When the blower 140 is arranged on upstream side and the exhaust device 170 is arranged on downstream side, it is possible to blow air along a flow of sewage. Further, when the blower 140 and the exhaust device 170 are arranged between the adjacent manholes, it is possible to shorten a distance between the air-blow and the air-exhaust, resulting in excellent ventilation efficiency.

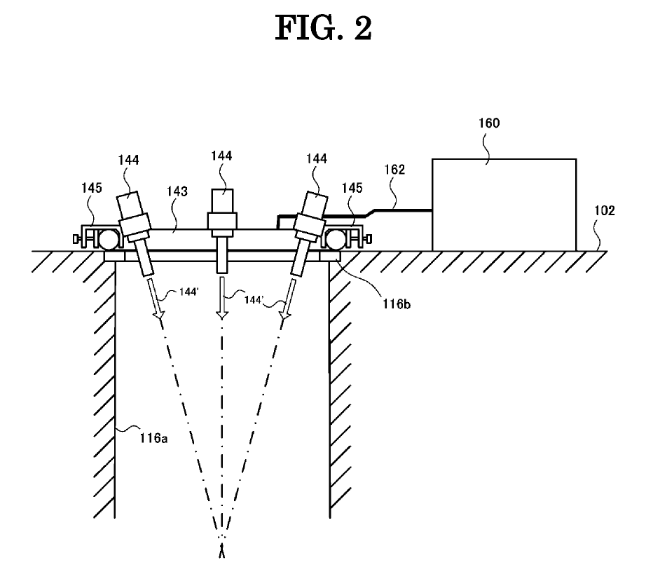

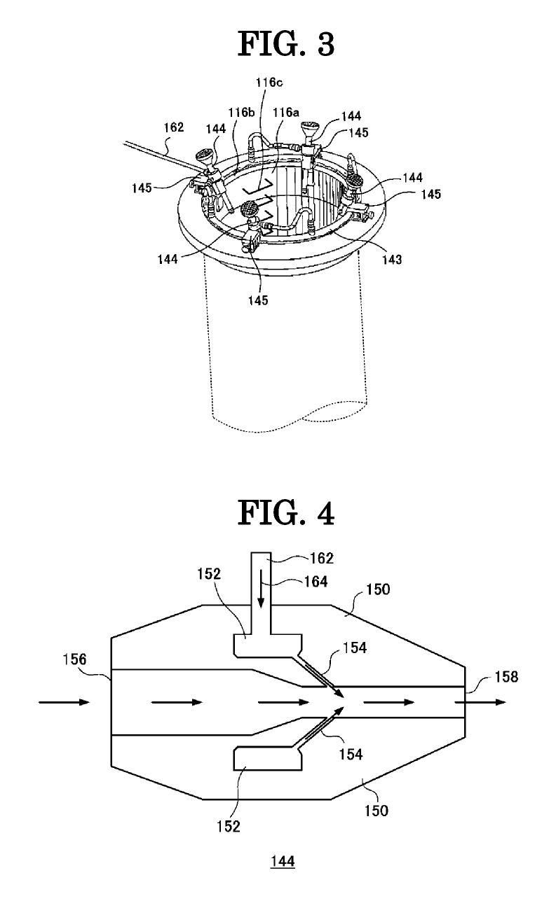

FIG. 2 is a cross-sectional view showing an example of the blower 140 installed in a manhole opening 116b, and FIG. 3 is a perspective view thereof. Reference numeral 116a shows a manhole inner wall, and reference numeral 116c shows a lifting fitting utilized when a worker entries or exits the manhole.

The blower 140 has a frame 143 and a nozzle 144, and the plurality of nozzles 144 are arranged along the frame 143. The frame 143 has a ring-like or circular arc-like outer appearance, and may be, for example, a hollow structure to be imparted with a function of a manifold for distributing compressed air. The nozzle 144 is supplied with compressed air through a pressure pipe 162 from a compressor 160. The nozzle 144 is supplied with the compressed air and blows the air in a direction of 144′

FIG. 4 is a cross-sectional view enlarging and showing an example of the nozzle 144 in an expanded manner. The nozzle 144 includes a body 150, and a space surrounded by the body 150 configures a cylindrical flow channel. The body 150 of the nozzle 144 is supplied with a compressed air 164 supplied from the pressure pipe 162, and the compressed air 164 is emitted from an outlet 154, by way of a buffer chamber 152, toward an exit port 158 of the cylindrical flow channel. The compressed air emitted from the outlet 154 flows in an exit-port direction while swallowing up the air in the cylindrical flow channel to generate airflow in the cylindrical flow channel. Thereby, the air suctioned from an entry port 156 of the cylindrical flow channel is released by the nozzle 144 from the exit port 158 of the cylindrical flow channel. When the compressed air swallows up the air in the cylindrical flow channel, an amount of air larger than that supplied as the compressed air is released from the nozzle 144. Normally, it is possible to release, from the nozzle 144, 10 times the amount of air as the supplied compressed air.

The nozzle 144 is installed at the frame 143 by an installation tool 145. The installation tool 145 may include an angle adjustment mechanism for adjusting the angle of the nozzle 144 relative to a disk surface of the frame 143. An installation angle of the nozzle 144 is adjusted by the angle adjustment mechanism so that each of the plurality of nozzles 144 can be arranged toward one point on a normal line of the center of the disk surface of the frame 143. This enables adjustment of an air-blow direction of the blower 140 toward the center of the manhole 116.

The installation tool 145 may include a clamp part for clamping the frame 143. In this case, it is possible that the clamp part makes the nozzle 144 detachable from the frame 143 and the angle of the nozzle 144 adjustable. Further, when the installation tool 145 includes the clamp part, the nozzle 144 is detachable by the clamp part from the frame 143, and therefore, the plurality of frames 143 each having various types of diameters corresponding to the manholes having various types of opening diameters are prepared, and the frame 143 appropriate for the opening diameter of the manhole is selected and the nozzle 144 is attached by the clamp part to the selected frame 143, as a result of which it is possible to easily comply with manholes having various diameters.

According to the present embodiment, there are four nozzles 144, and the four nozzles 144 are arranged at equal intervals along the frame 143. The number of nozzles is not limited to four, and at least two or more nozzles may suffice. However, in consideration of efficiency of air blow, the number of nozzles preferably is more than three. The more the nozzles, the better the efficiency of the air blow, however, an unnecessary large number of nozzles may result in a cost increase. Therefore, the number of nozzles preferably is decided on the basis of the balance between the air-blow efficiency and the cost.

The frame 143 may be configured by a plurality of members. In this case, when transported, the frame 143 may include either one of: a first configuration where the frame is separated in a plurality of members; or a second configuration where the frame is folded in a manner that the plurality of members are laid on top of one another. The frame 143 may further include a fixing tool for fixing at the manhole opening 116b. When the blower 140 is fixed at the manhole opening, it is possible to increase the safety level.

### Example 1

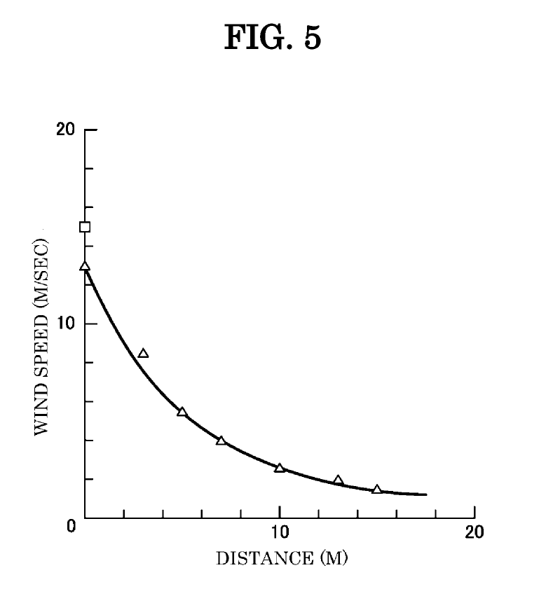

FIG. 5 is a graph showing a wind speed of a blower in Example 1 as a function of a distance. The blower 140 was installed at one end of a duct having an inner diameter of 600 mm and a length of 2000 mm, and the speed of an airflow released from the other end to a release space was measured with varying distances from the other end. A pressure of the compressed air was 0.69 MPa and an amount of air was 2.5 m³/min. The farther away from a duct end, the lower the wind speed, however it was confirmed that there was a condition that a required wind speed of 0.8 m/sec is obtained. It is noted that a square plot in FIG. 5 indicates data when the length of a duct is 980 mm.

### Example 2

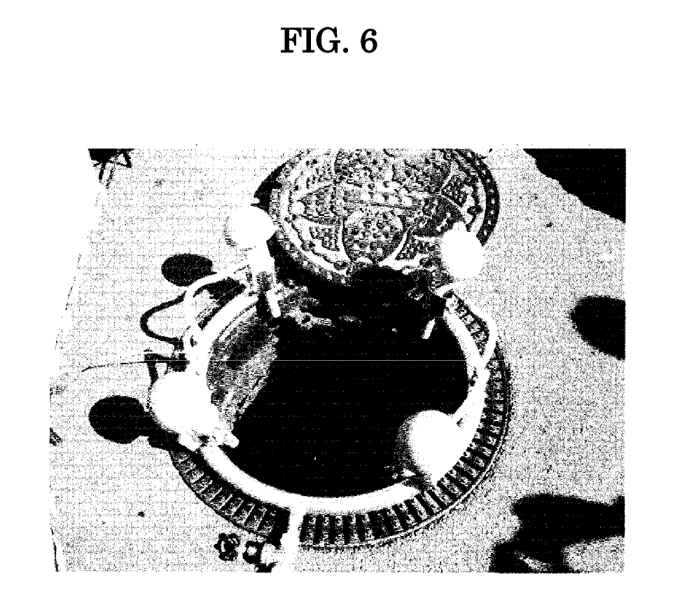

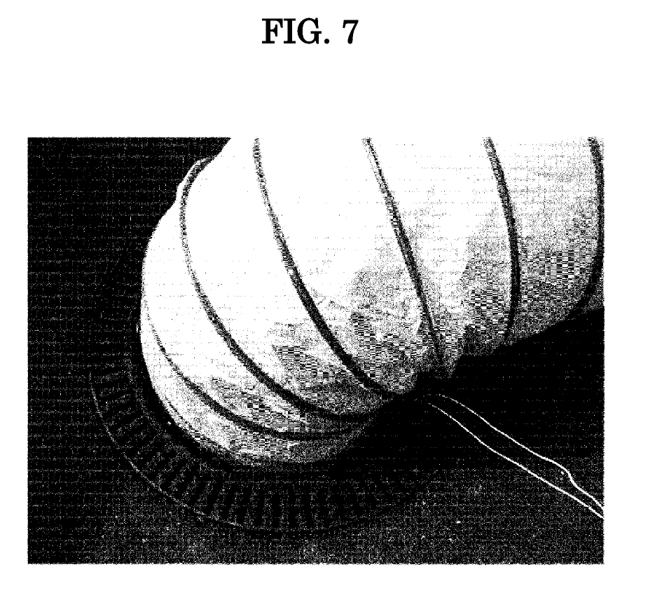

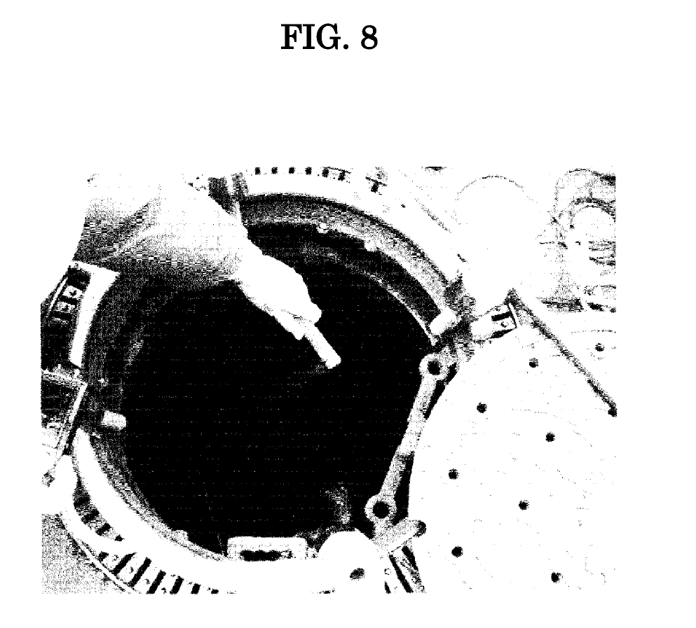

In Example 2, an example will be described that the ventilation system 100 shown in FIG. 1 is applied to an actual sewer pipe conduit. The sewer pipe conduit is of horseshoe of 2110 mm×2110 mm, and the area of the cross section is 3.82 m². A distance between the manhole 116 and the manhole 118 is about 60 m. FIG. 6 is a reference photograph showing a state where the blower 140 is arranged at the manhole opening at the air-blow side, and FIG. 7 is a reference photograph showing a state where the duct of the fan-type exhaust device is inserted into the manhole opening at the air-exhaust side. FIG. 8 is a reference photograph showing a state where the air is blown into the manhole when the blower is operated. In FIG. 8, it is seen a state where smoke of incense sticks is flown into the manhole and the air is blown into the manhole.

Table 1 shows a result obtained when a wind speed was measured in the pipe conduit 110. Measurement points were two in which one was a point (manhole) 2 m away from the manhole 116 and the other was a point (middle point) 30 m away from the manhole 116. For comparison, a conventional fan-type blower was used and measured. Comparative Example 1 is a case where the duct has a diameter of 300 mm, and Comparative Example 2 is a case where the duct has a diameter of 500 mm.

TABLE 1

| | Example | | Com. Ex. 1 | | Comp. Ex. 2 | |
|---|---|---|---|---|---|---|
| | wind | air | wind | air | wind | air |
| | speed | volume | speed | volume | speed | volume |
| Position | (m/s) | (m³/min) | (m/s) | (m³/min) | (m/s) | (m³/min) |
| manhole | 0.52 | 119.1 | 0.41 | 93.9 | 1.13 | 258.7 |
| Middle | 0.27 | 61.8 | 0.10 | 22.9 | 0.19 | 43.5 |

In the vicinity of the manhole, both the wind speed and the air volume in Comparative Example 2 of conventional type are larger than those of the blower 140, however, at the middle point, both the wind speed and the air volume in the ventilation system according to the present example are superior. A work in the pipe conduit is not necessarily carried out in the vicinity of the manhole, and it is rather necessary to ensure safety in work at the middle point. In this regard, the ventilation system according to the present example is superior to the conventional system.

As described above, according to the ventilation system 100 of the present invention, it is possible to achieve an excellent performance (wind speed, air volume) equivalent to or more than the conventional ventilation system. In addition, the blower 140 of the present ventilation system 100 is different from the conventional fan-type blower and does not need a flexible duct. Thus, it is possible to make the blower smaller in size. Further, in the blower 140 of the present invention, the manhole opening is not blocked as the conventional blower, so that an entry or an exit of a worker and an import or an export of an article are facilitated, and it is not necessary to stop the operation of the blower 140 during importation or exportation. Moreover, it is possible to ensure an escape route in emergency, and possible to further increase the safety of a worker.

Thus, the present invention is described by using an embodiment; however, the technical scope of the present invention is not limited to the scope of the above-described embodiment. It is evident to those skilled in the art that various modifications or improvements can be added to the embodiment above. It is also evident, based on the recitation of the claims, that the aspects to which the various modifications or improvements have been added may be also included in the technical scope of the present invention.

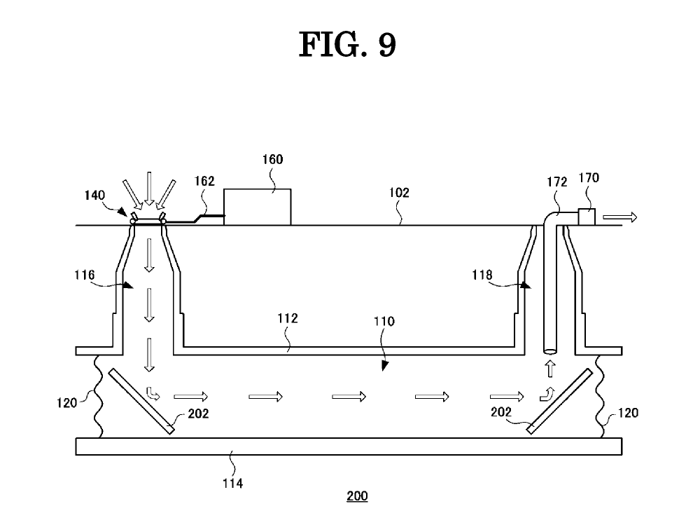

For example, FIG. 9 is a cross-sectional view showing another example of the ventilation system of the sewer pipe conduit. In a ventilation system 200 shown in FIG. 9, an airflow reflection plate 202 for converting a direction of airflow from a vertical direction to a horizontal direction or from a horizontal direction to a vertical direction is installed on a bottom of either one or both of the manhole 116 in which the blower 140 is installed and the manhole 118 in which the exhaust device 170 is installed. Such an airflow reflection plate 202 regulates a flow of air and reduces energy loss of an airflow generated when the direction of the flow of air is changed to achieve a more smooth flow, and as a result of which it is possible to increase the flow speed and the air volume in the pipe conduit 110.

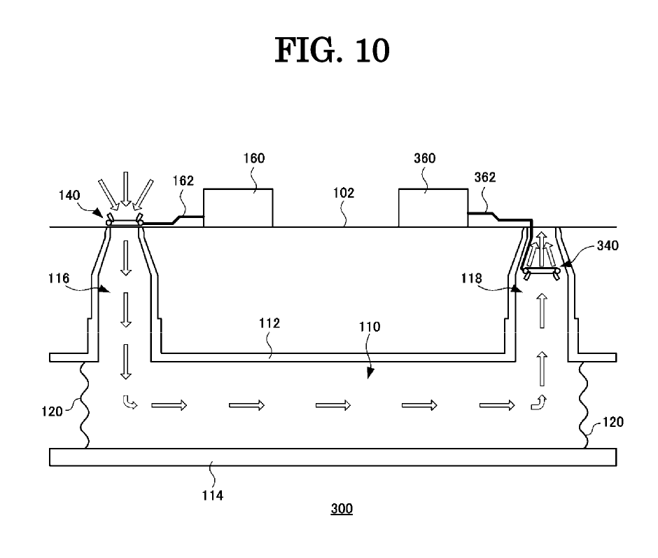

Further, FIG. 10 is a cross-sectional view showing still another example of a ventilation system of a sewer pipe conduit. In a ventilation system 300 shown in FIG. 10, the blower 140 of the present invention is installed at the manhole 116 at the air-blow side, and in addition, a blower 340 equivalent to the blower 140 of the present invention is installed also at the manhole 118 at the air-exhaust side. The nozzle of the blower 340 is supplied with the compressed air through an exhaust pressure pipe 362 from an exhaust compressor 360. According to the ventilation system 340, the blower 340 of the present invention is installed also at the manhole 118 at the air-exhaust side, so that exhaust performance is improved, an entry or an exit of a worker and an import or an export of an article are further facilitated, and it is possible to further increase the safety of a worker while ensuring a plurality of escape routes in emergency.

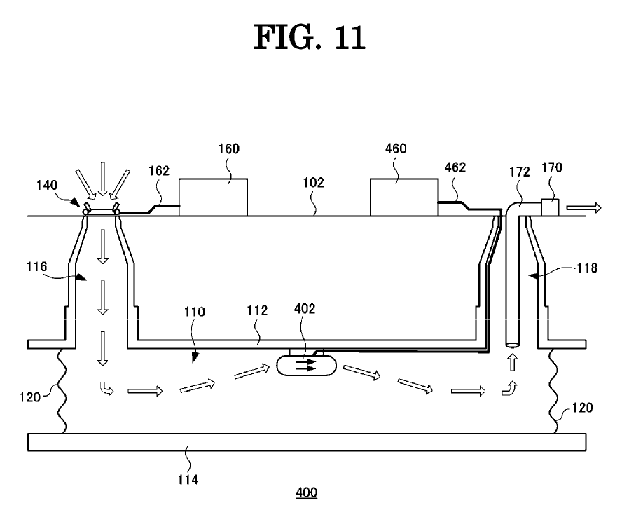

Further, FIG. 11 is a cross-sectional view showing yet another example of a ventilation system of a sewer pipe conduit. A ventilation system 400 shown in FIG. 10 is provided with a booster 402 in the pipe conduit 110. In the booster 402, a blower equivalent to the blowers 140 and 340 is provided so that the compressed air is supplied through a booster pressure pipe 462 from a booster compressor 460. The booster 402 generates an airflow in a direction to accelerate a flow in the pipe conduit 110. According to the ventilation system 400, the airflow in the pipe conduit 110 is boosted by the booster 402, and thus, it is possible to further increase the safety of a worker. It is noted that in the ventilation system 400, instead of the exhaust device 170 and the duct 172, the blower 340 may be installed at the manhole 118 at the air-exhaust side as in the ventilation system 300.

In the above-described embodiment, as the blower 140, an example is described in which the nozzle 144 having a cylindrical flow channel is arranged discontinuously along the frame 143; however, an opening of the nozzle may be arranged sequentially or continuously along the frame. For example, a nozzle having a slit-like opening is adopted, compressed air is supplied to a flow channel connected to the slit-like opening, the compressed air is emitted in a normal direction of a disk surface of which the frame is periphery, and the compressed air is emitted while swallowing up the surrounding air. In this way, the airflow may be generated in the normal direction of the disk surface. An opening of the slit-like nozzle may be formed continuously all across the entire frame, and an opening with an appropriate length of in a slit-like nozzle may be arranged continuously along the frame.

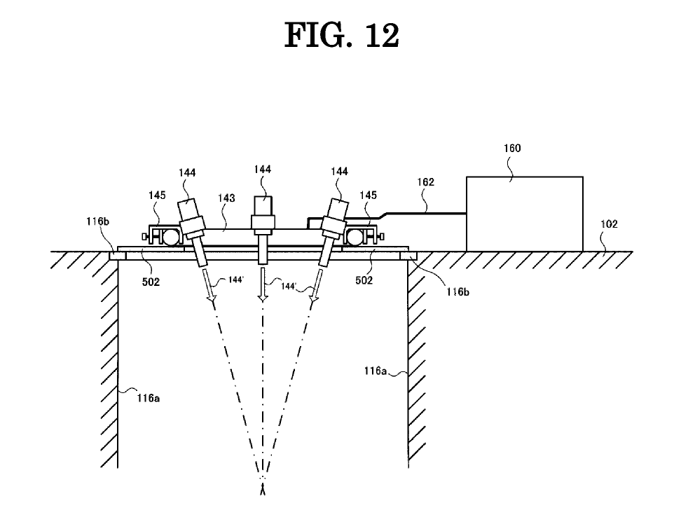

In the above-described embodiment, an example is described that the frame 143 suitable for the diameter of the manhole opening 116b is applied, however, as shown in FIG. 12, a blockage member 502 and the frame 143 having a diameter smaller than the diameter of the manhole opening 116b may be applied to the manhole 116 having a larger opening. The blockage member 502 is to block a gap between a circumferential area of the manhole opening 116b and the frame 143, and is capable of making the frame 143 suitable for the manhole opening 116b having a larger diameter.

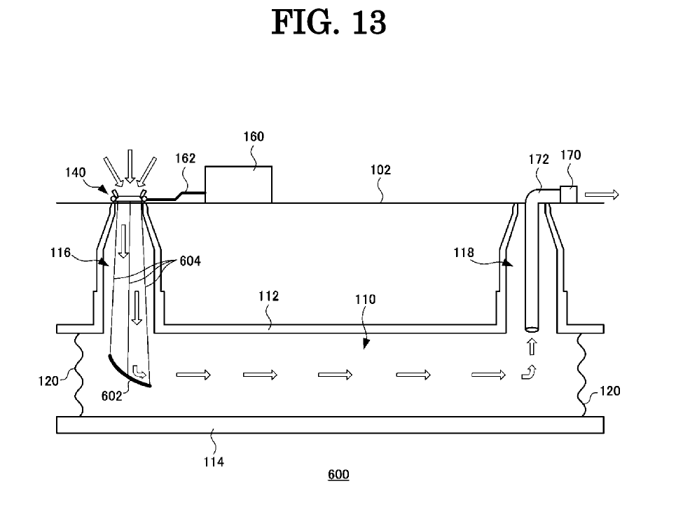

Further, as shown in FIG. 13, the blower 140 may include an airflow reflection member 602. The airflow reflection member 602 is a flexible member such as nylon, for example, and converts the direction of air flow from a vertical direction to a horizontal direction. The airflow reflection member 602 installed at the manhole opening 116b is dropped, by a rope member 604, for example, to a lower part in the manhole 116. The airflow reflection member 602 and the rope member 604 can be stored in a compact manner by folding, and convenient to expand by simply being installed at the manhole opening 116b and then dropped.

Further, in the above-described embodiment, aromatic supplying means for supplying the air or the compressed air 164 flown to the nozzle 144 with an aromatic may be further provided. As the aromatic supplying means, an aromatic may be simply placed at a flow entry port of air, for example. When the aromatic is supplied, it is possible for a worker working in the pipe conduit 110 to know that the air is normally supplied.

### REFERENCE SIGNS LIST

100 ventilation system, 102 ground surface, 110 pipe conduit, 112 wall surface, 114 bottom, 116 manhole, 116a manhole inner wall, 116b manhole opening, 116c lifting fitting, 118 manhole, 120 shield curtain, 140 blower, 143 frame, 144 nozzle, 145 installation tool, 150 body, 152 buffer chamber, 154 outlet, 156 entry port, 158 exit port, 160 compressor, 162 pressure pipe, 164 compressed air, 170 exhaust device, 172 duct, 200 ventilation system, 202 airflow reflection plate, 300 ventilation system, 340 blower, 360 exhaust compressor, 362 exhaust pressure pipe, 400 ventilation system, 402 booster, 460 booster compressor, 462 booster pressure pipe, 502 blockage member, 602 airflow reflection member, 604 rope member

1. A blower, comprising:
a ring-like or circular arc-like frame;
a nozzle arranged continuously or discontinuously along the frame; and
compressed air supplying means for supplying the nozzle with compressed air, wherein
the compressed air supplied from the compressed air supplying means is emitted while swallowing up air in the nozzle or near the nozzle, whereby, an airflow to a normal direction of a disk surface of which the frame is periphery is generated.

2. The blower according to claim 1, wherein
the nozzle is a nozzle for exhausting the air flown from an entry port of the cylindrical flow channel to an exit port of the cylindrical flow channel, and
a plurality of nozzles are arranged discontinuously along the frame.

3. The blower according to claim 2, wherein
an outlet from which compressed air is emitted toward the exit port is provided on a wall surface of the cylindrical flow channel, and
the compressed air emitted from the outlet is flown in a direction of the exit port while swallowing up the air in the cylindrical flow channel and thereby an airflow is generated in the cylindrical flow channel.

4. The blower according to claim 2, wherein
each of the plurality of nozzles is arranged toward one point on a normal line of the center of a disk surface of the frame.

5. The blower according to claim 2, wherein
the number of nozzles is four, and
the four nozzles are arranged at equal intervals along the frame.

6. The blower according to claim 2, comprising an installation tool for installing the nozzle to the frame, wherein
the installation tool includes an angle adjustment mechanism for adjusting an angle of the nozzle relative to the disk surface of the frame.

7. The blower according to claim 6, wherein
the installation tool includes a clamp part for clamping the frame, and by the clamp part, the nozzle is detachable from the frame, and the angle of the nozzle is adjustable.

8. The blower according to claim 1, wherein
the frame is configured by a plurality of members, and
when transported, the frame includes either one of: a first configuration where the frame is separated in the members; or a second configuration where the frame is folded in a manner that the plurality of members are laid on top of one another.

9. The blower according to claim 1, further comprising:
a fixing tool for fixing the frame to the manhole opening.

10. The blower according to claim 1, further comprising:
a blockage member for blocking a gap between a circumferential area of the manhole opening and the frame.

11. The blower according to claim 1, further comprising:
an airflow reflection member, which is a installed at the manhole opening, is flexible member dropped to a lower part in a manhole while being installed at the manhole opening, and converts a direction of an airflow from a vertical direction to a horizontal direction.

12. The blower according to claim 1, further comprising:
aromatic supplying means for supplying air or the compressed air flown to the nozzle with an aromatic.

13. A ventilation system of an underground pipe conduit or an underground pipe line, using the blower comprising a ring-like or circular arc-like frame, a nozzle arranged continuously or discontinuously along the frame, and compressed air supplying means for supplying the nozzle with compressed air, wherein the compressed air supplied from the compressed air supplying means is emitted while swallowing up air in the nozzle or near the nozzle, whereby, an airflow to a normal direction of a disk surface of which the frame is periphery is generated, wherein
the blower is installed in at least one manhole out of a plurality of manholes connected to the underground pipe conduit or the underground pipe line, and an exhaust device is installed in at least one of other manholes different from the manhole in which the blower is installed.

14. The blower according to claim 13, wherein
the nozzle is a nozzle for exhausting the air flown from an entry port of the cylindrical flow channel to an exit port of the cylindrical flow channel, and
a plurality of nozzles are arranged discontinuously along the frame.

15. The blower according to claim 14, wherein
an outlet from which compressed air is emitted toward the exit port is provided on a wall surface of the cylindrical flow channel, and
the compressed air emitted from the outlet is flown in a direction of the exit port while swallowing up the air in the cylindrical flow channel and thereby an airflow is generated in the cylindrical flow channel.

16. The blower according to claim 14, wherein
each of the plurality of nozzles is arranged toward one point on a normal line of the center of a disk surface of the frame.

17. The blower according to claim 14, wherein
the number of nozzles is four, and
the four nozzles are arranged at equal intervals along the frame.

18. The blower according to claim 14, comprising an installation tool for installing the nozzle to the frame, wherein
the installation tool includes an angle adjustment mechanism for adjusting an angle of the nozzle relative to the disk surface of the frame.

19. The blower according to claim 18, wherein
the installation tool includes a clamp part for clamping the frame, and by the clamp part, the nozzle is detachable from the frame, and the angle of the nozzle is adjustable.

20. The blower according to claim 13, wherein
the frame is configured by a plurality of members, and
when transported, the frame includes either one of: a first configuration where the frame is separated in the members; or a second configuration where the frame is folded in a manner that the plurality of members are laid on top of one another.

21. The blower according to claim 13, further comprising:
a fixing tool for fixing the frame to the manhole opening.

22. The blower according to claim 13, further comprising:
a blockage member for blocking a gap between a circumferential area of the manhole opening and the frame.

23. The blower according to claim 13, further comprising:
an airflow reflection member, which is a installed at the manhole opening, is flexible member dropped to a lower part in a manhole while being installed at the manhole opening, and converts a direction of an airflow from a vertical direction to a horizontal direction.

24. The blower according to claim 13, further comprising:
aromatic supplying means for supplying air or the compressed air flown to the nozzle with an aromatic.

25. The ventilation system according to claim 13, wherein
the exhaust device is installed at a first manhole on downstream side of the manhole in which the blower is installed.

26. The ventilation system according to claim 25, wherein on the bottom of either one or both of the manhole in which the blower is installed and the manhole in which the exhaust device is installed,
an airflow reflection plate for converting a direction of airflow from a vertical direction to a horizontal direction or from a horizontal direction to a vertical direction is installed.
